(19) United States
(12) Patent Application Publication
(10) Pub. No.: US 2018/0282351 A1
(43) Pub. Date: Oct. 4, 2018

(54) Amorphous Ixazomib Citrate

(71) Applicant: Mylan Laboratories Ltd, Hyderabad (IN)

(72) Inventors: Vinayak GORE, Hyderabad (IN); Rajesh JOSHI, Hyderabad (IN); Anil TRIPATHI, Hyderabad (IN); Madhukar PATIL, Hyderabad (IN); Ramakoteswara Rao JETTI, Hyderabad (IN); Anjaneyaraju INDUKURI, Hyderabad (IN); Amit SINGH, Hyderabad (IN); Soumyajit GHOSH, Hyderabad (IN)

(73) Assignee: Mylan Laboratories Ltd, Hyderabad (IN)

(21) Appl. No.: 15/758,868

(22) PCT Filed: Sep. 15, 2016
(86) PCT No.: PCT/IN2016/050311

§ 371 Date: Mar. 9, 2018

(30) Foreign Application Priority Data
Sep. 16, 2015 (IN) 4958/CHE/2015
Oct. 7, 2015 (IN) 5364/CHE/2015

(51) Int. Cl. C07F 5/02

(52) U.S. Cl. CPC C07F 5/025; C07B 2200/13

(57) ABSTRACT

The present disclosure provides amorphous ixazomib citrate and processes for the preparation thereof. Crystalline form M1, form M2, form M3, and form M4 of ixazomib citrate are also disclosed. The present disclosure also encompasses processes for the preparation of those crystalline forms.

### CROSS-REFERENCE TO RELATED APPLICATIONS

This application claims the benefit of Indian provisional patent applications No. 4958/CHE/2015 filed on Sep. 16, 2015, and 5364/CHE/2015 filed on Oct. 7, 2015, which are each hereby incorporated by reference in its entirety.

### BACKGROUND OF THE INVENTION

### Field of the Invention

The present invention relates generally to amorphous ixazomib citrate, crystalline polymorphs of ixazomib citrate, crystalline solvates of ixazomib citrate, and processes for the preparation thereof.

### Background of the Invention

Ixazomib citrate (known previously as MLN9708), shown below as Formula-I, is a prodrug for ixazomib. Chemically, ixazomib citrate is known as 2,2′-{2-[(1R)-1-({[(2,5-dichlorobenzoyl)amino]acetyl}amino)-3-methylbutyl]-5-oxo-1,3,2-dioxaborolane-4,4-diyl}diacetic acid. Ixazomib, which is formed from the rapid hydrolysis of ixazomib citrate under physiological conditions, is a proteasome inhibitor. As such, ixazomib and prodrugs thereof (e.g. ixazomib citrate) may be useful in the treatment for multiple myeloma.

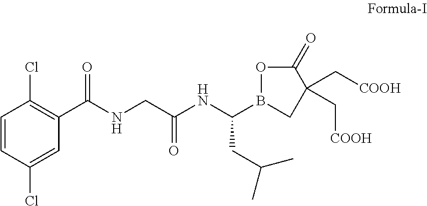 [SMILES: CC(C)C[C@H](NC(=O)CNC(=O)c1cc(Cl)ccc1Cl)B1CC(CC(=O)O)(CC(=O)O)C(=O)O1]

U.S. Pat. No. 8,859,504 discloses ixazomib citrate and process for the preparation thereof. It also discloses crystalline form 1 and form 2 of ixazomib citrate.

The present invention provides amorphous ixazomib citrate, novel polymorphs of ixazomib citrate, novel solvates of ixazomib citrate, and processes for the preparation thereof.

### SUMMARY OF THE INVENTION

In one aspect, the present invention provides amorphous ixazomib citrate.

In another aspect, the present invention provides processes for the preparation of amorphous ixazomib citrate.

In one embodiment, amorphous ixazomib citrate may be prepared by a process that includes the following steps:
a) providing a solution of citric acid in a first solvent;
b) providing a solution of N,N′,N″-[boroxin-2,4,6-triyltris[[(1R)-3-methylbutane-1,1-diyl]imino(2-oxoethane-2,1-diyl)]]tris(2,5-dichlorobenzamide) in a second solvent;
c) adding the solution of citric acid to the solution of N,N′,N″-[boroxin-2,4,6-triyltris[[(1R)-3-methylbutane-1,1-diyl]imino(2-oxoethane-2,1-diyl)]]tris(2,5-dichlorobenzamide) to form a mixture;
d) heating the mixture; and
e) removing the first and second solvents to isolate amorphous ixazomib citrate.

Within the context of this embodiment, a solution of citric acid is provided, which may be carried out by dissolving citric acid in the a first solvent.

Next, an N,N′,N″-[boroxin-2,4,6-triyltris[[(1R)-3-methylbutane-1,1-diyl]imino(2-oxoethane-2,1-diyl)]]tris(2,5-dichlorobenzamide solution is provided, which may be carried out by dissolving N,N′,N″-[boroxin-2,4,6-triyltris[[(1R)-3-methylbutane-1,1-diyl]imino(2-oxoethane-2,1-diyl)]]tris(2,5-dichlorobenzamide) in a second solvent.

Within the context of the present invention, the solvents used to dissolve citric acid and N,N′,N″-[boroxin-2,4,6-triyltris[[(1R)-3-methylbutane-1,1-diyl]imino(2-oxoethane-2,1-diyl)]]tris(2,5-dichlorobenzamide may be independently chosen from the group consisting of alcohol solvents, ketone solvents, chlorinated solvents, hydrocarbon solvents, ether solvents, and mixtures thereof.

Examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone, and mixtures thereof. Examples of suitable hydrocarbon solvents include, but are not limited to, heptane, hexane, and mixtures thereof. Examples of suitable chlorinated solvents include, but are not limited to, dichloromethane, dichloroethane, chloroform, and mixtures thereof. Examples of suitable ether solvents include, but are not limited to, 1,4-dioxane, diethyl ether, diisopropyl ether, cyclopentyl methyl ether, ethyl tert-butyl ether, methyl tert-butyl ether, tetrahydrofuran, and mixtures thereof.

Within the context of the present invention, the solution of citric acid and the solution of N,N′,N″-[boroxin-2,4,6-triyltris[[(1R)-3-methylbutane-1,1-diyl]imino(2-oxoethane-2,1-diyl)]]tris(2,5-dichlorobenzamide may be added together and the mixture may be heated. Next, the solvent (e.g., the first and second solvent) may be removed. This may be done by methods well known in the art, for example, by evaporation, distillation, spray drying, lyophilization, agitated thin film drying, or combinations thereof.

In another embodiment, amorphous ixazomib citrate may be prepared by a process that includes the following steps:
a) dissolving ixazomib citrate in a solvent; and
b) removing the solvent to isolate amorphous ixazomib citrate.

Within the context of this embodiment, ixazomib citrate may be dissolved in a solvent. The solvent may be, for example, an alcohol solvent, a ketone solvent, a chlorinated solvent, a hydrocarbon solvent, an ether solvent, or mixtures thereof.

Examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone. Examples of suitable hydrocarbon solvents include, but are not limited to, heptane, hexane, and mixtures thereof. Examples of suitable chlorinated solvents include, but are not limited to, dichloromethane, dichloroethane, chloroform, and mixtures thereof. Examples of suitable ether solvents include, but are not limited to, 1,4-dioxane, diethyl ether, diisopropyl ether, cyclopentyl methyl ether, ethyl tert-butyl ether, methyl tert-butyl ether, tetrahydrofuran, and mixtures thereof.

Next, the solvent may be removed, for example, by evaporation, distillation, spray drying, lyophilization, agitated thin film drying, or combinations thereof.

In another embodiment, amorphous ixazomib citrate may be prepared by a process that includes the following steps:
a) dissolving ixazomib citrate in a first solvent to form a solution;
b) adding the solution to a non-polar solvent; and
c) isolating amorphous ixazomib citrate.

Within the context of this embodiment, the first solvent may be, for example, an alcohol solvent, a ketone solvent, a chlorinated solvent, an ester solvent, or any mixtures thereof.

Examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone, and mixtures thereof. Examples of suitable chlorinated solvents include, but are not limited to, dichloromethane, dichloroethane, chloroform, and mixtures thereof.

Next, a non-polar solvent may be added. Examples of suitable non-polar solvents include hydrocarbon solvents, ether solvents, and mixtures thereof.

Examples of suitable hydrocarbon solvent include, but are not limited to, heptane, hexane, cyclohexane, toluene, and mixtures thereof. Examples of suitable ether solvent include, but are not limited to, 1,4-dioxane, diethyl ether, diisopropyl ether, cyclopentyl methyl ether, ethyl tert-butyl ether, methyl tert-butyl ether, and mixtures thereof.

Within the context of the present invention, the ixazomib citrate form M1 prepared according to processes disclosed herein may be characterized by a powder X-ray diffraction pattern having significant peaks at 6.05, 12.10, and 14.36±0.2° 2θ.

Crystalline ixazomib citrate form M1 may be further characterized by the powder X-ray diffraction pattern as shown in FIG. 1.

In another aspect, the present invention provides a process for preparing crystalline ixazomib citrate form M1.

In one embodiment, crystalline ixazomib citrate form M1 may be prepared by a process that includes the following steps:
a) dissolving ixazomib citrate in a mixture of ethanol and an organic solvent to form a solution; and
b) isolating crystalline ixazomib citrate form M1.

According to the present embodiment, ixazomib citrate may be dissolved in a mixture of ethanol and an organic solvent to form a solution. In some embodiments, this may be carried out at an elevated temperature. In such embodiments, the solution may be cooled before isolating crystalline ixazomib citrate form M1.

Within the context of this embodiment, the organic solvent may be an ether solvent, a hydrocarbon solvent, or mixtures thereof. Examples of suitable ether solvents include, but are not limited to, C₁₋₆ alkyl phenyl ethers (e.g., anisole, ethoxybenzene), diethyl ether, diisopropyl ether, cyclopentyl methyl ether, ethyl tert-butyl ether, methyl tert-butyl ether, tetrahydrofuran, or mixtures thereof.

Examples of suitable hydrocarbon solvents include, but are not limited to, hexane, heptane, and mixtures thereof.

In another embodiment, crystalline ixazomib citrate form M1 may be prepared by a process that includes the following steps:
a) forming a solution of ixazomib citrate in ethanol;
b) adding an organic solvent; and
c) isolating crystalline ixazomib citrate form M1.

According to the present embodiment, a solution of ixazomib citrate in ethanol may be formed. In some embodiments, this may be carried out by dissolving ixazomib citrate in ethanol. In other embodiments, ixazomib and citric acid may be independently dissolved in ethanol.

This step of forming a solution of ixazomib citrate in ethanol may be optionally carried out at an elevated temperature. In such embodiments, the solution may be cooled before adding an organic solvent.

Within the context of this embodiment, the organic solvent may be, an ether solvent, for example, C₁₋₆ alkyl phenyl ethers (e.g., anisole, ethoxybenzene), diethyl ether, diisopropyl ether, cyclopentyl methyl ether, ethyl tert-butyl ether, methyl tert-butyl ether, tetrahydrofuran, or mixtures thereof. In some particularly useful embodiments, anisole is used as the organic solvent.

In another aspect, the present invention provides crystalline ixazomib citrate form M2 which may be characterized by a PXRD pattern having significant peaks at 6.35, 12.97, 14.58, 19.11, and 20.88±0.2° 2θ.

Crystalline ixazomib citrate form M2 may be further characterized by a PXRD pattern as in FIG. 5.

In another aspect, the present invention provides a process for preparing crystalline ixazomib citrate form M2.

In one embodiment, a process for the preparation of crystalline ixazomib citrate form M2 may include the step of drying crystalline ixazomib citrate form M1.

Within the context of this embodiment, drying crystalline ixazomib citrate form M1 may be carried out at 30° C.-65° C.

In another aspect, the present invention provides crystalline ixazomib citrate form M3 which may be characterized by a PXRD pattern having significant peaks at 6.42, 10.63, 12.78, 14.81, 19.01, and 20.99±0.2° 2θ.

Crystalline ixazomib citrate form M3 may be further characterized by a PXRD pattern as shown in FIG. 9.

In another aspect, the present invention provides processes for the preparation of crystalline ixazomib citrate form M3.

In one embodiment, crystalline ixazomib citrate form M3 may be prepared by a process that includes the following steps:
a) dissolving ixazomib citrate in 1,4-dioxane to form a solution;
b) adding an organic solvent to the solution; and
c) isolating crystalline ixazomib citrate form M3.

According to this embodiment, ixazomib citrate may be dissolved in 1,4-dioxane. Optionally, this step may be carried out at an elevated temperature. In such embodiments, the solution may be cooled before adding an organic solvent.

Next, an organic solvent may be added. The organic solvent may be an ether solvent, a hydrocarbon solvent, or mixtures thereof. Examples of suitable ether solvents include, but are not limited to, C₁₋₆ alkyl phenyl ethers (e.g., anisole, ethoxybenzene), diethyl ether, diisopropyl ether, cyclopentyl methyl ether, ethyl tert-butyl ether, methyl tert-butyl ether, tetrahydrofuran, or mixtures thereof.

Examples of suitable hydrocarbon solvents include hexane, heptane, and mixtures thereof.

In some particularly useful embodiments, anisole is used as the organic solvent.

In another aspect, the present invention provides crystalline ixazomib citrate form M4, which may be characterized by a PXRD pattern having significant peaks at 6.26, 10.55, 14.77, 15.07, 18.92, 20.23, 21.00, 21.20, and 24.70±0.2° 2θ.

Crystalline ixazomib citrate form M4 may be further characterized by a PXRD pattern as shown in FIG. 13.

In yet another aspect, the present invention provides a process for the preparation of crystalline ixazomib citrate form M4, which may be carried out by a process that includes the step of drying crystalline ixazomib citrate form M3. Within the context of this embodiment, the drying of crystalline ixazomib citrate form M3 may be carried out at 95° C.-100° C.

### BRIEF DESCRIPTION OF THE DRAWINGS

Further aspects of the present disclosure together with additional features contributing thereto and advantages accruing there from will be apparent from the following description of embodiments of the disclosure which are shown in the accompanying drawing figures wherein:

FIG. 1 shows a powder X-ray diffraction (PXRD) pattern of crystalline ixazomib citrate form M1;

FIG. 2 shows a differential scanning calorimetry (DSC) thermogram of crystalline ixazomib citrate form M1:

FIG. 3 shows a thermal gravimetric analysis/differential thermal analysis (TGA/DTA) thermogram of crystalline ixazomib citrate form M1;

FIG. 4 shows a proton NMR (¹H NMR) spectrum of crystalline ixazomib citrate form M1;

FIG. 5 shows a PXRD pattern of crystalline ixazomib citrate form M2:

FIG. 6 shows a DSC thermogram of crystalline ixazomib citrate form M2;

FIG. 7 shows a TGA/DTA thermogram of crystalline ixazomib citrate form M2;

FIG. 8 shows a ¹H NMR spectrum of crystalline ixazomib citrate form M2;

FIG. 9 shows a PXRD pattern of crystalline ixazomib citrate form M3;

FIG. 10 shows a DSC thermogram of crystalline ixazomib citrate form M3;

FIG. 11 shows a TGA/DTA thermogram of crystalline ixazomib citrate form M3;

FIG. 12 shows a ¹H NMR spectrum of crystalline ixazomib citrate form M3;

FIG. 13 shows a PXRD pattern of crystalline ixazomib citrate form M4;

FIG. 14 shows a DSC thermogram of crystalline ixazomib citrate form M4;

FIG. 15 shows a TGA/DTA thermogram of crystalline ixazomib citrate form M4; and

FIG. 16 shows a PXRD pattern of amorphous ixazomib citrate.

### DETAILED DESCRIPTION OF THE INVENTION

In one aspect, the present invention provides crystalline ixazomib citrate form M1. The ixazomib citrate forms of the present invention, including form M1, prepared by methods disclosed herein, may be characterized by PXRD. Therefore samples of each ixazomib citrate form (including amorphous, M1, M2, M3, and M4) were analyzed by PXRD on a BRUKER D-8 Discover powder diffractometer equipped with a goniometer of θ/2θ configuration and Lynx Eye detector. The Cu-anode X-ray tube was operated at 40 kV and 30 mA. The experiments were conducted over the 2θ range of 2.0°-50.0°, 0.030° step size, and 0.4 seconds step time.

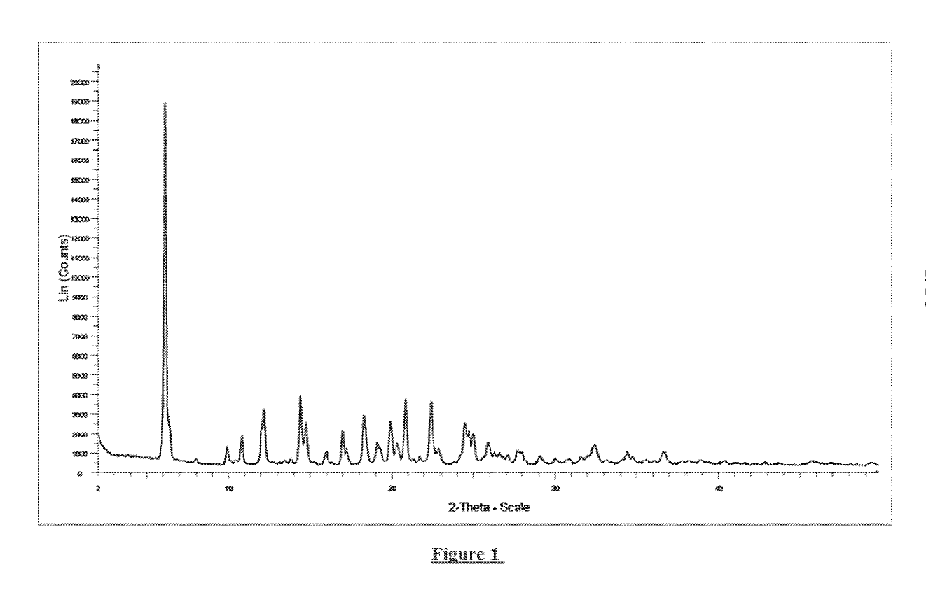

In some embodiments, crystalline ixazomib citrate form M1 may be characterized by a PXRD pattern having significant peaks at 6.05, 12.10, and 14.36±0.2° 2θ. The crystalline ixazomib citrate form M1 as disclosed herein may be further characterized by the PXRD pattern as shown in FIG. 1.

It is believed that crystalline ixazomib citrate form M1 obtained by the processes disclosed herein may be a solvated form of ixazomib citrate, specifically an ethanol solvate. It is further believed that crystalline ixazomib citrate form M1 is a monoethanolate (i.e., the ratio of ixazomib citrate to ethanol is 1:1).

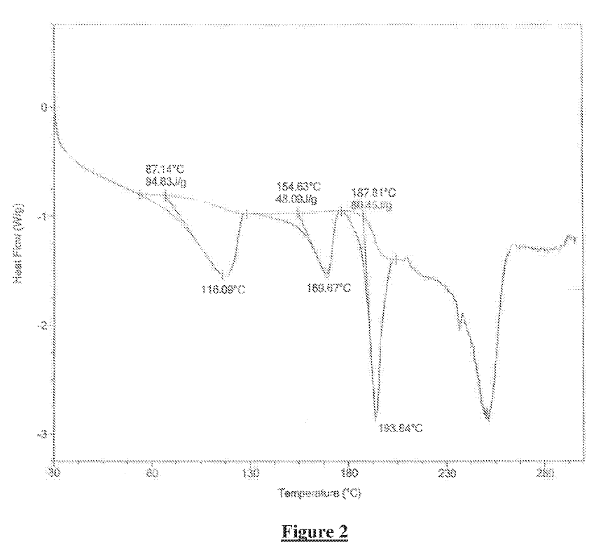

The crystalline ixazomib citrate forms of the present invention, including form M1, may also be characterized by differential scanning calorimetry (DSC). Therefore, samples of each ixazomib citrate form (including amorphous, M1, M2, M3, and M4) were analyzed by DSC on a TA Q1000 differential scanning calorimeter (TA Instruments). The experiments were performed at a heating rate of 10.0° C./min over a temperature range of 30° C.-300° C., purging with nitrogen at a flow rate of 50 mL/min. Standard aluminum crucibles covered by lids with pinholes were used. The crystalline ixazomib citrate form M1 as disclosed herein may be characterized by the DSC thermogram as shown in FIG. 2. It is believed that the peak at 116.09° C. in FIG. 2 is the loss of ethanol (to result in form M2), the peak at 169.67° C. is the conversion of form M2 to form 1, and the peak at 193.84° C. is the melting of the ixazomib citrate form 1.

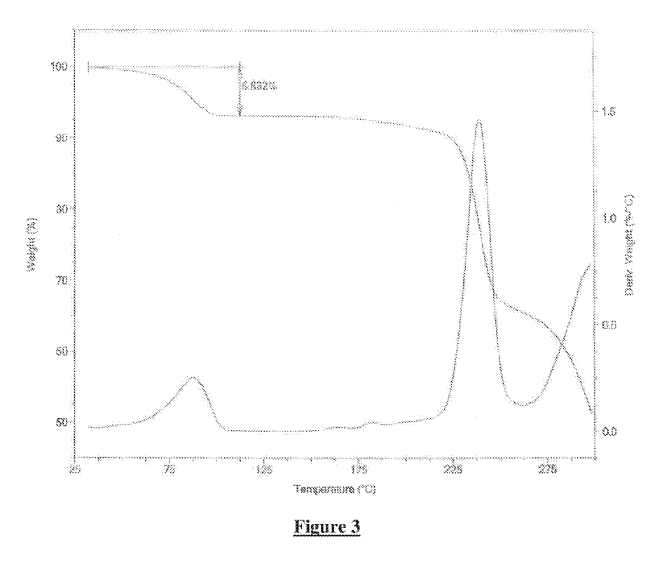

The crystalline ixazomib citrate forms of the present invention, including form M1, may also be characterized by thermogravimetric analysis (TGA) or differential thermal analysis (DTA). Therefore samples of each ixazomib citrate form (including amorphous, M1, M2, M3, and M4) were analyzed by TGA/DTA using a TA Q5000 SA (TA Instruments). The experiments were performed at a heating rate of 10.0° C./min over a temperature range of 30° C.-300° C., purging with nitrogen at a flow rate of 25 mL/min. The crystalline ixazomib citrate form M as disclosed herein may be characterized by the TGA/DTA thermogram as shown in FIG. 3. It is believed that the weight loss of 6.832% corresponds to the loss of ethanol.

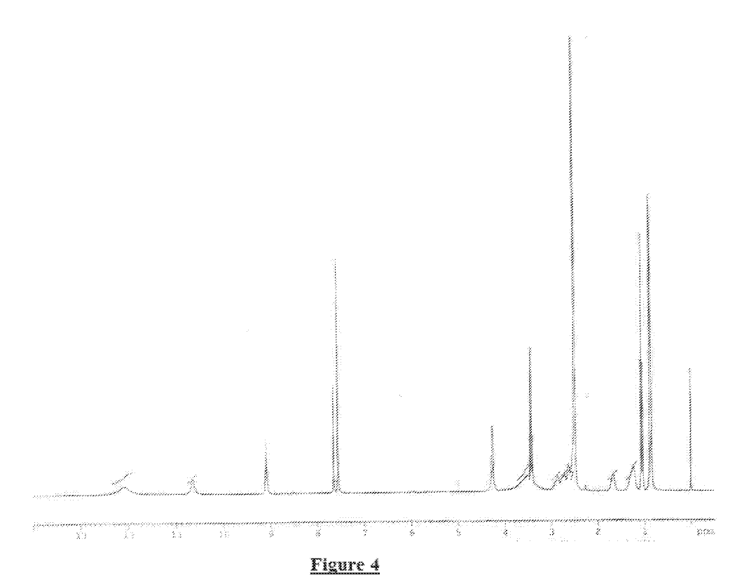

The crystalline ixazomib citrate forms of the present invention, including form M1, may be further characterized by proton NMR (¹H NMR). The samples of each ixazomib citrate form (including amorphous, M1, M2, M3, and M4) were analyzed by ¹H NMR on a Bruker 300 MHz Avance NMR spectrometer equipped with 5 mm BBI probe in DMSO-d₆. Data were collected and processed by Topsin-NMR software. The crystalline ixazomib citrate form M1 as disclosed herein may be characterized by the ¹H NMR spectrum as shown in FIG. 4. It is believed that the NMR signals at about 1 ppm, 3.4 ppm and 3.58 ppm correspond to ethanol.

In another aspect, the present invention provides a process for the preparation of crystalline ixazomib citrate form M1. Crystalline ixazomib citrate form M1 may be prepared by a process that includes the following steps:
a) dissolving ixazomib citrate in mixture of ethanol and an organic solvent to form a solution;
b) optionally cooling the solution; and
c) isolating crystalline ixazomib citrate form M1.

According to the present embodiment, ixazomib may first be dissolved in a mixture of ethanol and an organic solvent. Within the context of this embodiment, the organic solvent may be an ether solvent or a hydrocarbon solvent. Suitable ether solvents include, but are not limited to, diethyl ether, diisopropyl ether, anisole, cyclopentyl methyl ether, ethyl tert-butyl ether, methyl tert-butyl ether, tetrahydrofuran, and mixtures thereof. In certain embodiments, the ether solvent is aromatic. Examples of aromatic ether solvents include C₁₋₆ alkyl phenyl ethers such as anisole, ethoxybenzene, and the like. Suitable hydrocarbon solvents include, but are not limited to, hexane, heptane, and mixtures thereof. In some particularly useful embodiments, ixazomib citrate is dissolved in a mixture of ethanol and anisole. In some embodiments, a mixture with a ratio of 2:5 v/v ethanol:anisole is used.

In some embodiments, ixazomib citrate may be dissolved in a mixture of ethanol and an organic solvent optionally at an elevated temperature. In some particularly useful embodiments, this step is carried out at a temperature of about 70° C. to about 75° C.

Next, the solution may be optionally cooled. This step of cooling is particularly useful when the dissolving of ixazomib citrate in the mixture of ethanol and an organic solvent is done at an elevated temperature. Within the context of this embodiment, the solution may be cooled to a temperature of about 25° C. to about 30° C. As used herein, the term “about” means a range that includes the value specified plus or minus 10%.

Crystalline ixazomib citrate form M1 may then be isolated. This may be carried out by processes well known in the art. For example, the solution may be filtered to obtain solid crystalline ixazomib citrate form M1.

In another embodiment, crystalline ixazomib citrate form M1 may be prepared by a process that includes the following steps:
a) forming a solution of ixazomib citrate in ethanol;
b) optionally cooling the solution;
c) adding an organic solvent; and
d) isolating crystalline ixazomib citrate form M1.

According to the present embodiment, a solution of ixazomib citrate in ethanol may be formed. In some embodiments, this may be achieved by dissolving ixazomib citrate in ethanol. In some embodiments, the dissolving of ixazomib citrate in ethanol may be carried out at an elevated temperature. In some particularly useful embodiments, this step is carried out at a temperature of about 75° C. to about 80° C.

In other embodiments, the solution of ixazomib citrate in ethanol may be formed in situ by dissolving ixazomib in ethanol and adding citric acid.

Next, the solution may be optionally cooled. This step of cooling is particularly useful when the forming of a solution of ixazomib citrate in ethanol is done at an elevated temperature. Within the context of this embodiment, the solution may be cooled to a temperature of about 25° C. to about 30° C. As used herein, the term “about” means a range that includes the value specified plus or minus 10%.

Next, an organic solvent may be added. Within the context of this embodiment, the organic solvent may be an ether solvent or a hydrocarbon solvent. Suitable ether solvents include, but are not limited to, diethyl ether, diisopropyl ether, anisole, cyclopentyl methyl ether, ethyl tert-butyl ether, methyl tert-butyl ether, tetrahydrofuran, and mixtures thereof. In certain embodiments, the ether solvent is aromatic. Examples of aromatic ether solvents include C₁₋₆ alkyl phenyl ethers such as anisole, ethoxybenzene, and the like. Suitable hydrocarbon solvents include, but are not limited to, hexane, heptane, and mixtures thereof.

Crystalline ixazomib citrate form M1 may then be isolated. This may be carried out by processes well known in the art. For example, the solution may be filtered to obtain solid crystalline ixazomib citrate form M1.

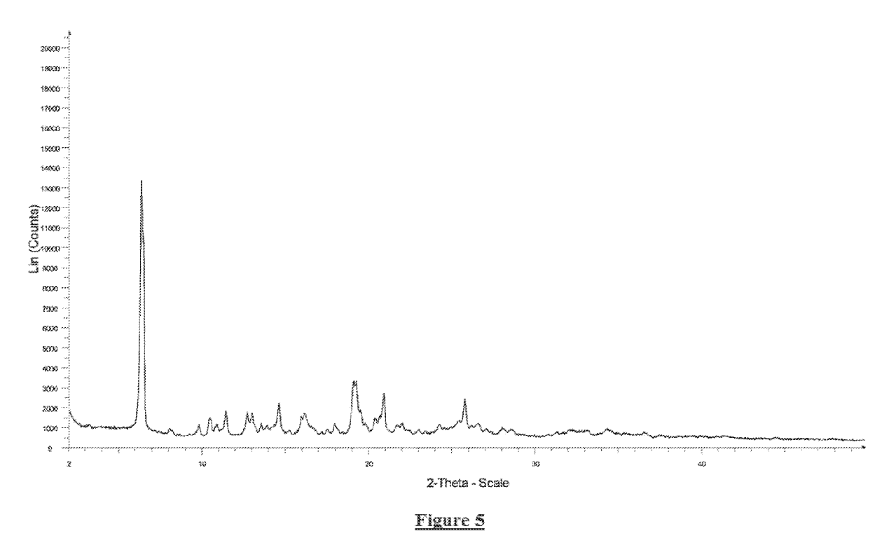

In another aspect, the present invention provides crystalline ixazomib citrate form M2. The crystalline ixazomib citrate form M2 disclosed herein may be characterized by a PXRD pattern having significant peaks at 6.35, 12.97, 14.58, 19.11, and 20.88±0.2° 20. The crystalline ixazomib citrate form M2 disclosed herein may be further characterized by the PXRD pattern as shown in FIG. 5.

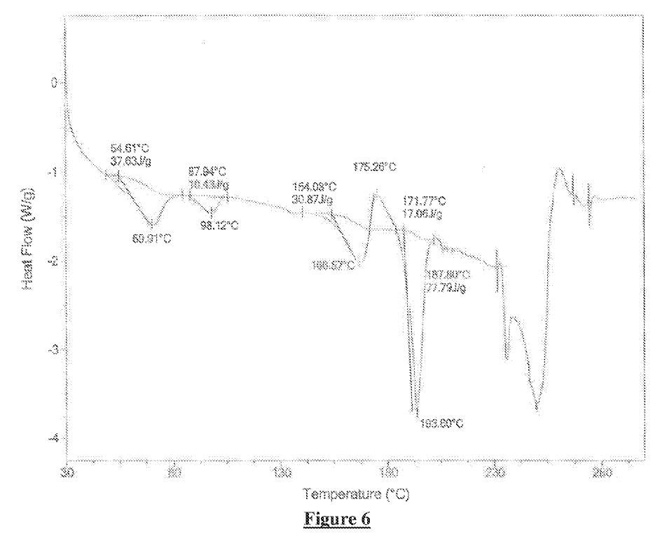

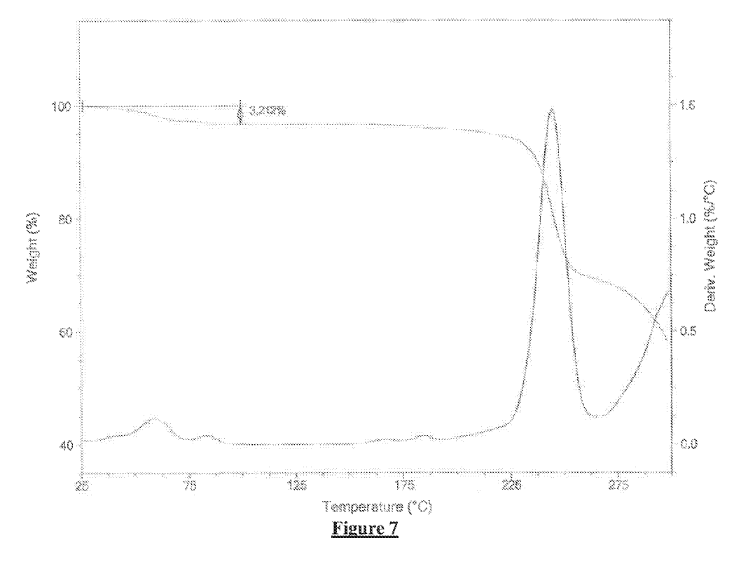

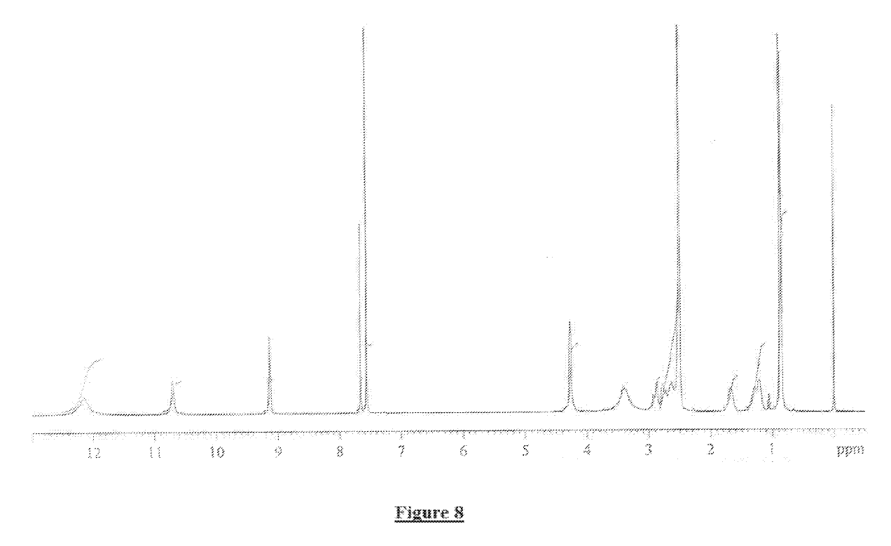

The ixazomib citrate crystalline form M2 disclosed herein may also be characterized by DSC, as shown in the DSC thermogram in FIG. 6. It is believed that the endothermic peaks at 69.91° C. and 98.12° C. correspond to a loss of moisture, that the peak at 166.57° C. is the conversion of form M2 to form 1, and that the peak at 193.80° C. is the melting of form 1. The ixazomib citrate crystalline form M2 disclosed herein may also be characterized by TGA or DTA, as shown in the TGA/DTA thermal curve in FIG. 7. It is believed that the weight loss of 3.212% noted in FIG. 7 corresponds to the loss of surficial moisture. The ixazomib citrate crystalline form M2 disclosed herein may also be characterized by the ¹H NMR spectrum as shown in FIG. 8. It is believed that the NMR signal at 3.3 ppm reflects surficial moisture.

In another aspect, the present invention provides a process for the preparation of crystalline ixazomib citrate form M2. In one embodiment, crystalline ixazomib citrate form M2 may be prepared by drying crystalline ixazomib citrate form M1 at a temperature and for a period of time suitable to provide ixazomib citrate form M2. For example, crystalline ixazomib citrate form M1 may be dried at a temperature of about 30° C. to about 65° C. to yield crystalline ixazomib citrate form M2. In particularly useful embodiments, drying crystalline ixazomib citrate form M1 at a temperature of about 40° C. to about 60° C. is used to yield crystalline ixazomib citrate form M2.

Crystalline ixazomib citrate form M2, prepared by methods disclosed herein, may exhibit long-term physical stability. For example, Table I below shows PXRD data collected on crystalline ixazomib citrate form M2 prepared by methods disclosed herein. Data collected shows that crystalline ixazomib citrate form M2 does not show any change in PXRD pattern over the periods tested (i.e., is stable at 1, 3, and 6 months) when stored at 5±3° C., at 25° C./60% and at 40° C./75% relative humidity (RH).

TABLE 1

| | Stability of Form M2 | | |
|---|---|---|---|
| | Condition/Polymorph | | |
| | at 40° C./75% RH | at 25° C./60% RH | at 5 ± 3° C. |
| | PXRD | PXRD | PXRD |
| Initial | Form M2 | Form M2 | Form M2 |
| 1 month | Form M2 | Form M2 | Form M2 |
| 3 months | Form M2 | Form M2 | Form M2 |
| 6 months | Form M2 | Form M2 | Form M2 |

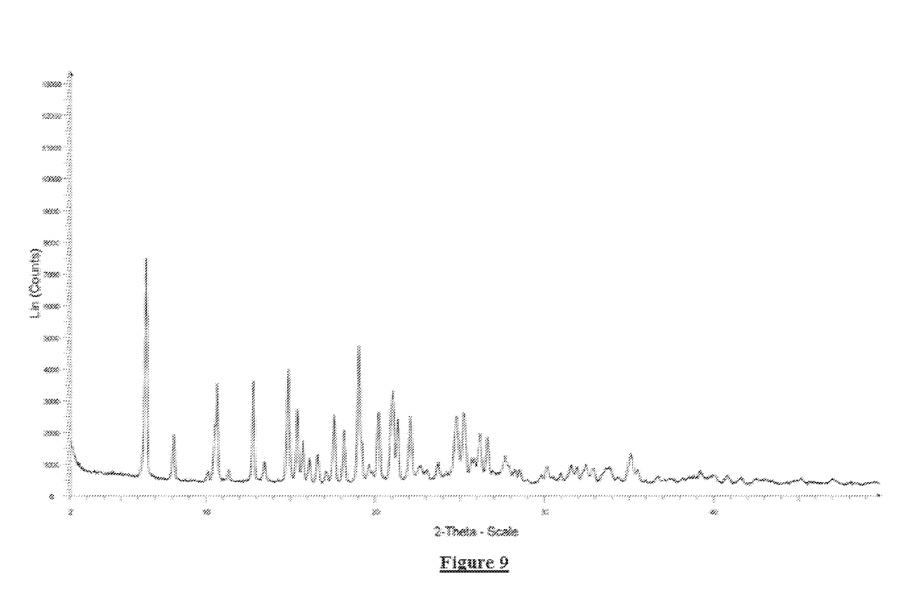

In another aspect, the present invention provides crystalline ixazomib citrate form M3. The crystalline ixazomib citrate form M3 disclosed herein may be characterized by a PXRD pattern having significant peaks at 6.42, 10.63, 12.78, 14.81, 19.01, and 20.99±0.2° 2θ. The crystalline ixazomib citrate form M3 as disclosed herein may be further characterized by a PXRD pattern having peaks at 6.42, 8.06, 10.63, 14.81, 15.37, 17.54, 18.13, 19.01, 20.17, 20.99, 21.32, 22.07, 24.78, 25.23, 26.16, and 26.62±0.2° 2θ. The crystalline ixazomib citrate form M3 disclosed herein may be further characterized by the PXRD pattern as shown in FIG. 9.

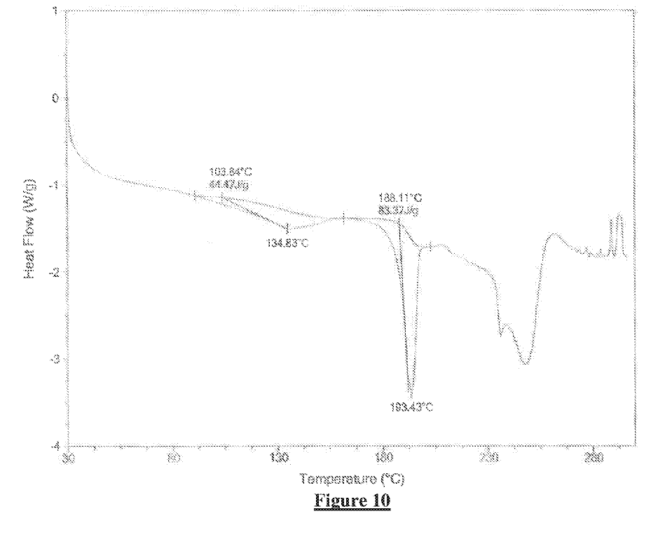

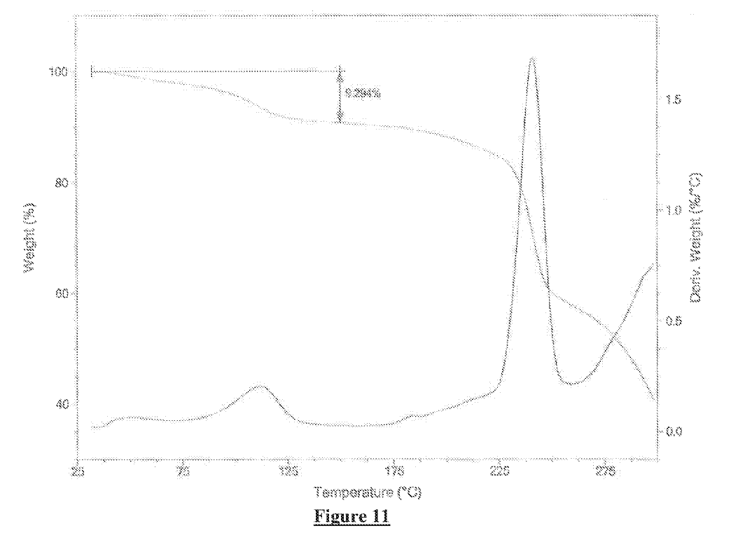

It is believed that crystalline ixazomib citrate form M3 obtained by the processes disclosed herein may be a solvated form of ixazomib citrate, specifically a dioxane solvate. It is further believed that crystalline ixazomib citrate for M3 is a hemi-dioxane solvate (i.e., that the ratio of ixazomib citrate to dioxane is 1:0.5). Crystalline ixazomib citrate form M3 as disclosed herein may be characterized by the DSC thermogram as shown in FIG. 10. It is believed that the peak at 134.83° C. reflects the loss of dioxane, and the peak at 193.43° C. reflects the melting of the desolvated ixazomib citrate. Crystalline ixazomib citrate form M3 as disclosed herein may also be characterized by the TGA/DTA thermogram in FIG. 11. It is believed that the weight loss of 9.294% noted in FIG. 11 corresponds to the loss of dioxane solvent and surficial moisture.

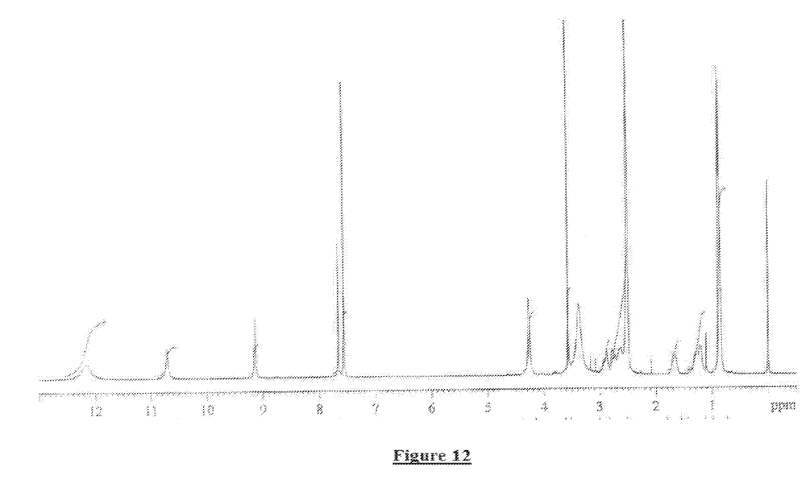

Further, the crystalline ixazomib citrate form M3 as disclosed herein may be characterized by the ¹H NMR spectrum shown in FIG. 12. It is believed that the NMR signal at 3.56 ppm corresponds to —CH2 protons of dioxane.

In another aspect, the present invention provides a process for the preparation of crystalline ixazomib citrate form M3. Within the context of this embodiment, crystalline ixazomib citrate form M3 may be prepared by a process that includes the following steps:
a) dissolving ixazomib citrate in 1,4-dioxane to form a solution;
b) optionally cooling the solution;
c) adding an organic solvent; and
d) isolating crystalline ixazomib citrate form M3.

According to the present embodiment, ixazomib citrate may be first dissolved in 1,4-dioxane to form a solution. In some embodiments, the step of dissolving ixazomib citrate in 1,4-dioxane may be optionally carried out at an elevated temperature. In some particularly useful embodiments, this step is carried out at about 75° C. to 80° C.

Next, the solution may be optionally cooled. This step of cooling is particularly useful when the dissolving of ixazomib citrate in 1,4-dioxane is done at an elevated temperature. Within the context of this embodiment, the solution may be cooled to a temperature of about 25° C. to about 30° C. As used herein, the term “about” means a range that includes the value specified plus or minus 10%.

According to the present embodiment, an organic solvent may then be added to the solution.

Within the context of this embodiment, the organic solvent may be an ether solvent or a hydrocarbon solvent. Suitable ether solvents include, but are not limited to, diethyl ether, diisopropyl ether, anisole, cyclopentyl methyl ether, ethyl tert-butyl ether, methyl tert-butyl ether, tetrahydrofuran, and mixtures thereof. In certain embodiments, the ether solvent is aromatic. Examples of aromatic ether solvents include C₁₋₆ alkyl phenyl ethers such as anisole, ethoxybenzene, and the like. Suitable hydrocarbon solvents include, but are not limited to, hexane, heptane, and mixtures thereof.

Crystalline ixazomib citrate form M3 may then be isolated. This may be carried out by processes well known in the art. For example, the solution may be filtered to obtain solid crystalline ixazomib citrate form M3.

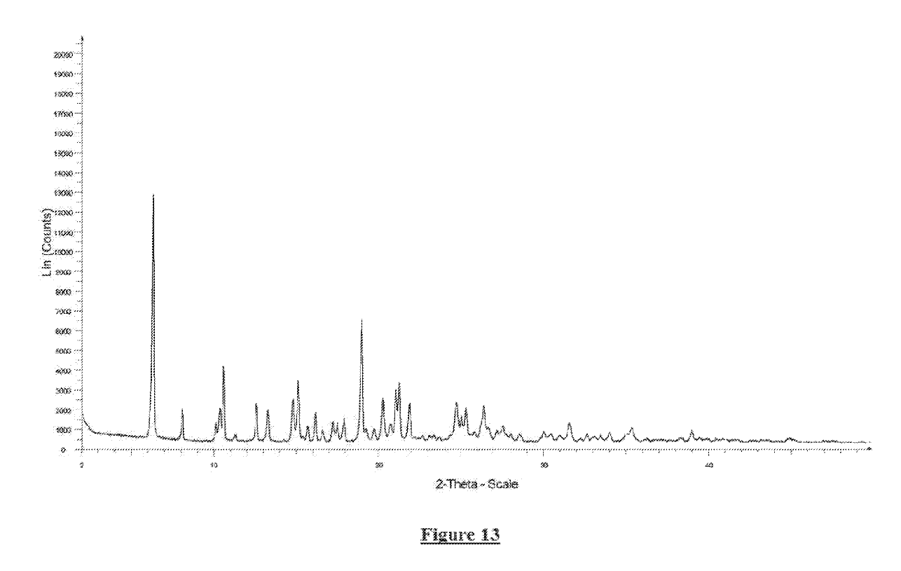

In another aspect, the present invention provides crystalline ixazomib citrate form M4. The crystalline ixazomib citrate form M4 may be characterized by a PXRD pattern having significant peaks at 6.26, 10.55, 14.77, 15.07, 18.92, 20.23, 21.00, 21.20, and 24.70±0.2° 2θ. The crystalline ixazomib citrate form M4 disclosed herein may be further characterized by the PXRD pattern as shown in FIG. 13.

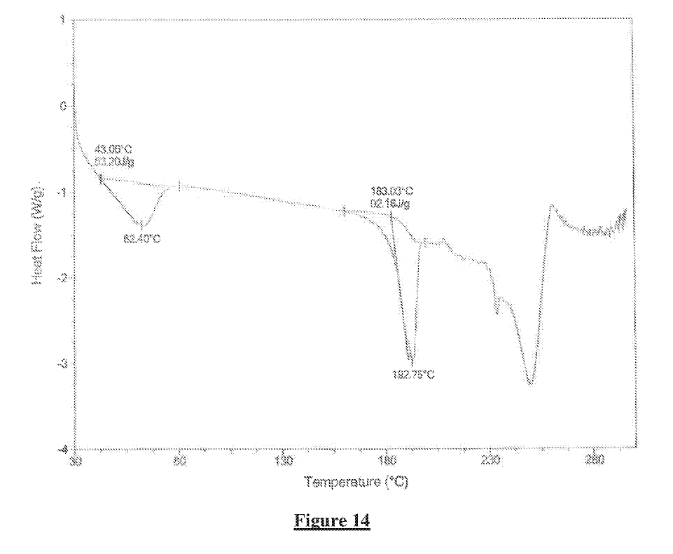

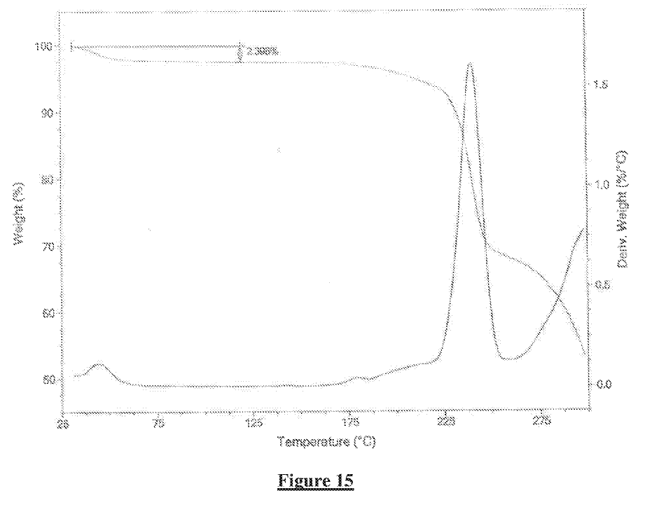

The crystalline ixazomib citrate form M4 disclosed herein may also be characterized by the DSC thermogram in FIG. 14. It is believed that the peak at 62.40° C. corresponds to the loss of moisture and that the peak at 192.75° C. corresponds to melting of the ixazomib citrate. The crystalline ixazomib citrate form M4 disclosed herein may be characterized by the TGA/DTA thermogram as shown in FIG. 15. It is believed that the weight loss of 2.395% noted in FIG. 15 corresponds to loss of surficial moisture.

In another aspect, the present invention provides a process for the preparation of crystalline ixazomib citrate form M4. Within the context of this embodiment, crystalline ixazomib citrate form M4 may be prepared by drying crystalline ixazomib citrate form M3 at a temperature and for a period of time suitable to provide ixazomib citrate form M4. For example, crystalline ixazomib citrate form M3 may be dried at a temperature of about 95° C. to about 100° C. to yield crystalline ixazomib citrate form M4. In particularly useful embodiments, drying crystalline ixazomib citrate form M3 at a temperature of about 100° C. is used to yield crystalline ixazomib citrate form M4.

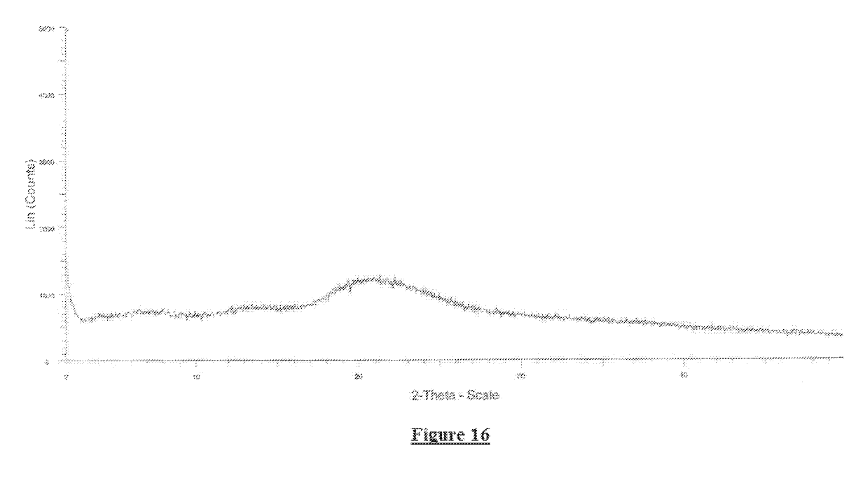

In another aspect, the present invention provides amorphous ixazomib citrate. The amorphous ixazomib citrate disclosed herein may be characterized by the PXRD pattern in as shown FIG. 16.

In another aspect, the present invention provides a process for the preparation of amorphous ixazomib citrate. Within the context of this embodiment, amorphous ixazomib citrate may be prepared by a process that includes the following steps:
a) providing a first solution of citric acid dissolved in a first solvent;
b) providing a second solution of N,N′,N″-[boroxin-2,4,6-triyltris[[(1R)-3-methylbutane-1,1-diyl]imino(2-oxoethane-2,1-diyl)]]tris(2,5-dichlorobenzamide) dissolved in a second solvent;
c) combining the first solution of citric acid to the second solution of N,N′,N″-[boroxin-2,4,6-triyltris[[(1R)-3-methylbutane-1,1-diyl]imino(2-oxoethane-2,1-diyl)]]tris(2,5-dichlorobenzamide) to form a mixture;
d) heating the mixture; and
e) removing the first and second solvents from the mixture to isolate amorphous ixazomib citrate.

According to the present embodiment, a solution of citric acid may be provided. Within the context of this embodiment, the citric acid solution may be prepared by dissolving citric acid in a first solvent. Next, a N,N′,N″-[boroxin-2,4,6-triyltris[[(1R)-3-methylbutane-1,1-diyl]imino(2-oxoethane-2,1-diyl)]]tris(2,5-dichlorobenzamide) solution is provided. Within the context of this embodiment, the N,N′,N″-[boroxin-2,4,6-triyltris[[(1R)-3-methylbutane-1,1-diyl]imino(2-oxoethane-2,1-diyl)]]tris(2,5-dichlorobenzamide) solution may be prepared by dissolving N,N′,N″-[boroxin-2,4,6-triyltris[[(1R)-3-methylbutane-1,1-diyl]imino(2-oxoethane-2,1-diyl)]]tris(2,5-dichlorobenzamide) in a second solvent.

Examples of suitable first and second solvents include alcohol solvents, ketone solvents, chlorinated solvents, hydrocarbon solvents, ether solvents, or mixtures thereof. Within the context of this embodiment, examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone, and mixtures thereof. Examples of suitable hydrocarbon solvents include, but are not limited to, heptane, hexane, and mixtures thereof. Examples of suitable chlorinated solvents include, but are not limited to, dichloromethane, dichloroethane, chloroform, and mixtures thereof. Examples of suitable ether solvents include, but are not limited to, 1,4-dioxane, diethyl ether, diisopropyl ether, cyclopentyl methyl ether, ethyl tert-butyl ether, methyl tert-butyl ether, tetralydrofuran, and mixtures thereof.

Within the context of the present invention, the first and second solvent may be the same or they may be different.

Next, the citric acid solution and the N,N′,N″-[boroxin-2,4,6-triyltris[[(1R)-3-methylbutane-1,1-diyl]imino(2-oxoethane-2,1-diyl)]]tris(2,5-dichlorobenzamide) may be combined to form a mixture.

According to this embodiment, the mixture may then be heated. In some useful embodiments, the mixture is heated to about 60° C.

According to this embodiment, the solvents in the mixture may then be removed. This may be carried out by well-known techniques, including, for example, but not limited to, evaporation, distillation, spray drying, filtration, agitated thin film drying, or any combination thereof. In some embodiments, distillation is found to be particularly useful.

In another embodiment, amorphous ixazomib citrate may be prepared by a process that includes the following steps:
a) dissolving ixazomib citrate in a solvent; and
b) removing the solvent to isolate amorphous ixazomib citrate.

According to the present embodiment, ixazomib citrate may first be dissolved in a solvent. Examples of suitable solvents include alcohol solvents, ketone solvents, chlorinated solvents, hydrocarbon solvents, ether solvents, and mixtures thereof.

Within the context of this embodiment, examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone, and mixtures thereof. Examples of suitable hydrocarbon solvents include, but are not limited to, heptane, hexane, and mixtures thereof. Examples of suitable chlorinated solvents include, but are not limited to, dichloromethane, dichloroethane, chloroform, or mixtures thereof. Examples of suitable ether solvents include, but not are limited to, 1,4-dioxane, diethyl ether, diisopropyl ether, cyclopentyl methyl ether, ethyl tert-butyl ether, methyl tert-butyl ether, tetrahydrofuran, and mixtures thereof.

According to the present embodiment, the solvent may be removed by well-known techniques, for example, but not limited to, by evaporation, distillation, spray drying, filtration, agitated thin film drying, or combinations thereof. In some particularly useful embodiments, distillation is used.

In another embodiment, amorphous ixazomib citrate may be prepared by a process that includes the following steps:
a) dissolving ixazomib citrate in a first solvent to form a solution;
b) adding the solution to a non-polar solvent; and
c) isolating amorphous ixazomib citrate.

According to the present embodiment, ixazomib citrate may be dissolved in a first solvent to form a solution. Within the context of this embodiment, the solvent may be, for example, an alcohol solvent, a ketone solvent, a chlorinated solvent, an ester solvent, or mixtures thereof.

Within the context of this embodiment, examples of suitable alcohol solvents include, but are not limited to, methanol, ethanol, propanol, isopropanol, n-butanol, 2-butanol, isobutanol, t-butanol, pentanol, and mixtures thereof. Examples of suitable ketone solvents include, but are not limited to, acetone, methyl ethyl ketone, methyl isobutyl ketone, and mixtures thereof. Examples of suitable chlorinated solvents include, but are not limited to, dichloromethane, dichloroethane, chloroform, and mixtures thereof. Examples of suitable ester solvents include, but are not limited to, ethyl acetate, isopropyl acetate, and mixtures thereof. In some embodiments, ethyl acetate is used.

Next, the solution may be added to a non-polar solvent. Examples of suitable non-polar solvents include ether solvents, hydrocarbon solvents, or mixtures thereof. Within the context of this embodiment, examples of suitable hydrocarbon solvents include, but are not limited to, heptane, hexane, cyclohexane, toluene, or mixtures thereof. Examples of suitable ether solvents include, but are not limited to, 1,4-dioxane, diethyl ether, diisopropyl ether, cyclopentyl methyl ether, ethyl tert-butyl ether, methyl tert-butyl ether, and mixtures thereof. In some particularly useful embodiments, cyclohexane is used.

Each form of ixazomib citrate, including forms M1, M2, M3, M4, and the amorphous form disclosed herein and prepared by the disclosed methods, may be included in an oral dosage form, such as a tablet or a capsule. When administered to patients, the ixazomib citrate of the present invention, in any of the forms disclosed, may be useful in the treatment of individuals with multiple myeloma. Ixazomib citrate and the forms thereof disclosed herein may be used singly or in combination with other drugs, such as lenalidomide and dexamethasone.

The ixazomib citrate, including forms M1, M2, M3, M4, and the amorphous form of the present invention may be formulated into a capsule which may contain inactive ingredients such as microcrystalline cellulose, magnesium stearate, talc, and mixtures thereof. The capsule shell may, in some embodiments, includes additional excipients such as gelatin, titanium dioxide, black iron oxide, red iron oxide, yellow iron oxide, shellac, propylene glycol, potassium hydroxide, and other artificial colors and flavors. One of skill in the art will be familiar with a variety of excipients and formulations that may be used to prepare desirable dosage forms with desired release characteristics and pharmacokinetic properties without undue experimentation.

In view of the above description and the examples below, one of ordinary skill in the art will be able to practice the invention as claimed without undue experimentation. The foregoing will be better understood with reference to the following examples that detail certain procedures for the preparation of molecules according to the present invention. All references made to these examples are for the purposes of illustration. The following examples should not be considered exhaustive, but merely illustrative of only a few of the many aspects and embodiments contemplated by the present disclosure.

### EXAMPLES

### Example 1: Preparation of Amorphous Ixazomib Citrate

A solution of citric acid (2.77 g) in acetone (50 mL) was added to a solution of N,N′,N″-[boroxin-2,4,6-triyltris[[(1R)-3-methylbutane-1,1-diyl]imino(2-oxoethane-2,1-diyl)]]tris(2,5-dichlorobenzamide) (5 g) in acetone (50 mL) at 30±5° C. The mixture was heated and maintained at 60° C. for 5 hours. The obtained mixture was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 2: Preparation of Amorphous Ixazomib Citrate

Ixazomib citrate (1 g) was dissolved in acetone (25 mL) and the mixture was filtered through a Celite bed to obtain a clear solution. The resultant filtrate was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 3: Preparation of Amorphous Ixazomib Citrate

Ixazomib citrate (1 g) was dissolved in acetone (25 mL) and the mixture was filtered through a Celite bed to obtain a clear solution. The resultant filtrate was distilled under vacuum at 60° C. N-heptane (100 mL) was added to the obtained foamy solid and the mixture was distilled to remove the n-heptane solvent. This process was repeated once more to yield amorphous ixazomib citrate.

### Example 4: Preparation of Amorphous Ixazomib Citrate

Ixazomib citrate (1 g) was dissolved in tetrahydrofuran (25 mL) and the mixture was filtered through a Celite bed to obtain a clear solution. The resultant filtrate was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 5: Preparation of Amorphous Ixazomib Citrate

Ixazomib citrate (1 g) was dissolved in tetrahydrofuran (25 mL) and the mixture was filtered through a Celite bed to obtain a clear solution. The resultant filtrate was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 6: Preparation of Amorphous Ixazomib Citrate

Ixazomib citrate (1 g) was dissolved in acetone (50 mL) and the mixture was filtered through a Celite bed to obtain a clear solution. The resultant filtrate was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 7: Preparation of Amorphous Ixazomib Citrate

Ixazomib citrate (1 g) was dissolved in acetone (50 mL) and the mixture was filtered through a Celite bed to obtain a clear solution. The resultant filtrate was distilled under vacuum at 60° C. n-heptane (100 mL) was added to the obtained foamy solid and the mixture was distilled to remove the n-heptane solvent. This process was repeated once more to yield amorphous ixazomib citrate.

### Example 8: Preparation of Amorphous Ixazomib Citrate

Ixazomib citrate (1 g) was dissolved in tetrahydrofuran (50 mL) and the mixture was filtered through a Celite bed to obtain a clear solution. The resultant filtrate was distilled under vacuum at 60° C. Diisopropyl ether (DIPE, 100 mL) was added to the obtained foamy solid and the mixture was distilled to remove the DIPE solvent. This process was repeated once more to yield amorphous ixazomib citrate.

### Example 9: Preparation of Amorphous Ixazomib Citrate

Ixazomib citrate (1 g) was dissolved in tetrahydrofuran (50 mL) and the mixture was filtered through a Celite bed to obtain a clear solution. The resultant filtrate was distilled under vacuum at 60° C. N-heptane (100 mL) was added to the obtained foamy solid and the mixture was distilled to remove the n-heptane solvent. This process was repeated once more to yield amorphous ixazomib citrate.

### Example 10: Preparation of Amorphous Ixazomib Citrate

Ixazomib citrate (3 g) was dissolved in tetrahydrofuran (50 mL) and the mixture was filtered through a Celite bed to obtain a clear solution. The obtained filtrate was distilled under vacuum at 55±5° C. until a foamy white-off white solid was obtained. The reaction mass was cooled to 25±5° C. and dissolved in ethyl acetate (25 mL) to get a clear solution. This clear solution was added to cyclohexane (200 mL) and stirred for 30 minutes at 25±5° C. The obtained solid was filtered and dried at 55±5° C. to give amorphous ixazomib citrate.

### Example 11: Preparation of Crystalline Ixazomib Citrate Form M1

Ixazomib citrate (1 g) was dissolved in a mixture of ethanol (10 mL) and anisole (25 mL) at 75° C. The clear solution was kept at 25-30° C. without agitation for 24 hours. The mixture was filtered and the isolated solid was dried under vacuum to get a solid which was identified by PXRD as crystalline ixazomib citrate form M1.

### Example 12: Preparation of Crystalline Ixazomib Citrate Form M1

Ixazomib citrate (5 g) was dissolved in ethanol (50 mL) at 75-80° C. The solution was filtered at 65-70° C. to remove any undissolved particulate and then cooled to 25-30° C. Anisole (175 mL) was added at 25-30° C. and stirred at same temperature for 24 hours. The mixture was filtered and the isolated solid was washed with anisole (10 mL) and suck-dried under vacuum to get a solid which was identified by PXRD as crystalline ixazomib citrate form M1.

### Example 13: Preparation of Crystalline Ixazomib Citrate Form M1

Ixazomib citrate (1 g) was dissolved in ethanol (10 mL) at 75-80° C. The solution was filtered at 65-70° C. to remove any undissolved particulate and then cooled to 25-30° C. Methyl tert-butyl ether (30 mL) was added at 25-30° C. and the solution was stirred at same temperature for 18 hours. The mixture was filtered and the isolated solid was washed with methyl tert-butyl ether (2 mL) and suck-dried under vacuum to get a solid which was identified by PXRD as crystalline ixazomib citrate form M1.

### Example 14: Preparation of Crystalline Ixazomib Citrate Form M2

Ixazomib citrate (5 g) Form M1 was placed in petri-dish and dried at 40° C. under vacuum for 20 hours to get a solid which was identified by PXRD as crystalline ixazomib citrate form M2.

### Example 15: Preparation of Crystalline Ixazomib Citrate Form M2

Ixazomib citrate (2 g) was dissolved in a mixture of anisole (50 mL) and ethanol (20 mL) at 70° C. The clear solution was cooled to 25-30° C. and seeds of ixazomib citrate form M1 were added. The mixture was stirred at the same temperature for 24 hours. Anisole (20 mL) was added to the solution and stirred at 25-30° C. for 18 hours. The reaction mass was cooled to 0-5° C., stirred for 1 hour, the solution was filtered, then the isolated solid was dried under vacuum at 40-60° C. for 18 hours to get a solid which was identified by PXRD as crystalline ixazomib citrate form M2.

### Example 16: Preparation of Crystalline Ixazomib Citrate Form M3

Ixazomib citrate (1 g) was dissolved in 1,4-dioxane (10 mL) at 75-80° C. The clear solution was filtered at 60-70° C. to remove any undissolved particulate and then cooled to 25-30° C. Methyl tert-butyl ether (80 mL) was added to the solution at 25-30° C. and stirred at same temperature for 24 hours. The mixture was filtered and the isolated solid was dried under vacuum at 25-30° C. to get a solid which was identified by PXRD as crystalline ixazomib citrate form M3.

### Example 17: Preparation of Crystalline Ixazomib Citrate Form M3

Ixazomib citrate (1 g) was dissolved in 1,4-dioxane (20 mL) at 75-80° C. The clear solution was filtered at 60-70° C. to remove any undissolved particulate and then cooled to 25-30° C. Methyl tert-butyl ether (80 mL) was added to the solution at 25-30° C. and stirred at same temperature for 24 hours. The mixture was filtered and the isolated solid was dried under vacuum at 25-30° C. to get a solid which was identified by PXRD as crystalline ixazomib citrate form M3.

1. Amorphous ixazomib citrate.

2. A process for preparing amorphous ixazomib citrate, comprising the steps of:
a. dissolving ixazomib citrate in a solvent; and
b. removing the solvent to isolate amorphous ixazomib citrate.

3. The process according to claim 2, wherein the solvent is selected from the group consisting of an alcohol solvent, a ketone solvent, a chlorinated solvent, a hydrocarbon solvent, an ether solvent, and mixtures thereof.

4-8. (canceled)

9. The process according to claim 2, wherein the solvent is removed by evaporation, distillation, spray drying, lyophillization, agitated thin film drying, or combinations thereof.

10. A process for preparing amorphous ixazomib citrate, comprising the steps of:
a. dissolving ixazomib citrate in a first solvent to form a solution;
b. adding the solution to a non-polar solvent; and
c. isolating amorphous ixazomib citrate.

11. The process according to claim 10, wherein the first solvent is selected from the group consisting of alcohol solvents, ketone solvents, chlorinated solvents, ester solvents, and mixtures thereof.

12-14. (canceled)

15. The process according to claim 10, wherein the non-polar solvent is selected from the group consisting of hydrocarbon solvents, ether solvents, and mixtures thereof.

16-17. (canceled)

18. A process for preparing amorphous ixazomib citrate, comprising the steps of:
a. providing a solution of citric acid in a first solvent;
b. providing a solution of N,N′,N″-[boroxin-2,4,6-triyltris[[(1R)-3-methylbutane-1,1-diyl]imino(2-oxoethane-2,1-diyl)]]tris(2,5-dichlorobenzamide) in a second solvent;
c. adding the solution of citric acid to the solution of N,N′,N″-[boroxin-2,4,6-triyltris[[(1R)-3-methylbutane-1,1-diyl]imino(2-oxoethane-2,1-diyl)]]tris(2,5-dichlorobenzamide) to form a mixture;
d. heating the mixture; and
e. removing the first and second solvents to isolate amorphous ixazomib citrate.

19-20. (canceled)

21. The process according to claim 18, wherein the first and second solvents are independently selected from the group consisting of alcohol solvents, ketone solvents, chlorinated solvents, hydrocarbon solvents, ether solvents, and mixtures thereof.

22-26. (canceled)

27. The process according to claim 18, wherein the first and second solvents are removed by evaporation, distillation, spray drying, lyophilization, agitated thin film drying, or combinations thereof.

28-35. (canceled)

36. Crystalline ixazomib citrate form M2 characterized by a PXRD pattern having significant peaks at 6.35, 12.97, 14.58, 19.11, and 20.88±0.2° 2θ.

37. Crystalline ixazomib citrate form M2 of claim 36 characterized by a PXRD pattern as shown in FIG. 5.

38. A process for the preparation of crystalline ixazomib citrate form M2 comprising drying crystalline ixazomib citrate form M1.

39. The process according to claim 38, wherein the drying is carried out at 30° C.-65° C.

40-46. (canceled)

47. Crystalline ixazomib citrate form M4 characterized by a PXRD pattern having significant peaks at 6.26, 10.55, 14.77, 15.07, 18.92, 20.23, 21.00, 21.20, and 24.70±0.2° 2θ.

48. Crystalline ixazomib citrate form M4 of claim 47 characterized by a PXRD pattern as shown in FIG. 13.

49. A process for the preparation of crystalline ixazomib citrate form M4 comprising drying crystalline ixazomib citrate form M3.

50. The process according to claim 49, wherein the drying is carried out at 95° C.-100° C.
